(19) United States
(12) Patent Application Publication
(10) Pub. No.: US 2025/0318679 A1
(43) Pub. Date: Oct. 16, 2025

(54) COOKING RELEASE SHEET AND METHOD OF MAKING SAME

(71) Applicant: Textiles Coated, Incorporated, Londonderry, NH (US)

(72) Inventor: John W. TIPPETT, Londonderry, NH (US)

(21) Appl. No.: 19/170,696

(22) Filed: Apr. 4, 2025

Related U.S. Application Data
(60) Provisional application No. 63/632,713, filed on Apr. 11, 2024.

(51) Int. Cl. A47J 36/02; A47J 37/06; B32B 5/26; B32B 7/03; B32B 27/12; B32B 27/32

(52) U.S. Cl. CPC A47J 36/025; B32B 5/26; B32B 7/03; B32B 27/12; B32B 27/322; A47J 37/0611; B32B 2250/03; B32B 2250/242; B32B 2262/0253; B32B 2307/30; B32B 2307/7376

(57) ABSTRACT

A cooking release sheet of the type typically used in a clam shell cooker is fabricated as a laminate of at least two thin laminated layers of fibrillated polytetrafluoroethylene film and not prestressing the laminate exhibits less expansion when exposed to elevated temperatures. The material provides a uniform and efficient heat transfer that can withstand the high heat necessary for rapid cooking without deforming, and that is readily cleanable and does not negatively impact food safety issues resulting from wear, damage, or thermal or chemical degradation.

### PRIORITY

This application claims the benefit of U.S. Provisional Patent Application No. 63/632,713 filed Apr. 11, 2024, the entire contents of which are hereby incorporated by reference.

### BACKGROUND

The invention generally relates to release materials, laminates and other composites used in high temperature environments, and relates in particular to laminates that include polymeric materials that are used in the food industry in conditions that involve withstanding high temperatures.

Business enterprises in the food industry, including those in the preparation of food in restaurants, cafes, and the fast-food industry are seeking faster, more uniform methods of cooking food. Additionally, such businesses look to advance capabilities without impairing overall operations, including cost, cleanup tasks, food safety, and employee occupational hazards.

For example, the traditional method of cooking a hamburger involves placing a meat patty on a hot grill and flipping the half-cooked patty to complete the cooking process with the other side in contact with the grill. A clamshell grill is an example of a technological improvement where both sides of the hamburger patty are cooked simultaneously, thereby effectively cutting the cook time in half. The hamburger chef need not flip the burger half-way through the cooking process and the heated portion of the grill is not even exposed during the cooking process to minimize occupational exposure to spattering grease and heat. The clamshell grill is not limited to hamburgers since the preparation of nearly any type of entrée, sandwich, or heated snack can benefit from direct exposure to a cooking source of heat from two sides.

The challenge of implementing a successful clamshell grill in a food preparation environment is to provide a non-stick and food-safe (e.g., non-degrading) cooking surface that permits a uniform application of heat while ensuring that the food remains intact when the grill is opened upon completion of the cooking cycle. The industry has adopted the use of a removable and replaceable release sheet that is applied to the upper surface of the clamshell grill. The lower surface is typically not provided with a release sheet.

Such release sheets however must be thin enough to transfer the heat from an adjacent upper heating element to the food product being heated very quickly. Since the bottom side of the food product is also being subjected directly to a lower heating element, the heat from the upper heating element must work very quickly to evenly heat the food product.

Additionally however, the release sheet must be capable of withstanding the high heat from the upper heating element without deforming, particularly given that it is suspended from the upper heating element. The release sheet must also easily separate from (not stick to) the food product when the upper heating element is lifted.

While polytetrafluoroethylene (PTFE) is known to be used in thin films, laminates and composites at high temperatures (to provide an excellent non-stick surface), structural materials such as fiberglass have been added to PTFE to provide the required performance as a cooking release sheet. Unfortunately however, any passage of such composite reinforcement materials to the food product (e.g., as the release sheet ages) is both highly undesirable and difficult to predict and quantify.

Accordingly, there is a need for a non-stick release sheet that permits uniform and efficient heat transfer, that can withstand the high heat necessary for rapid cooking without deforming, and that is readily cleanable and does not negatively impact food safety issues resulting from wear, damage, or thermal or chemical degradation.

### SUMMARY

In accordance with an aspect of the invention, a cooking release sheet is provided that permits uniform and efficient heat transfer, that can withstand the high heat necessary for rapid cooking without deforming, and that is readily cleanable and does not negatively impact food safety issues resulting from wear, damage, or thermal or chemical degradation. The cooking release sheet is fabricated as a laminate of two layers. The first layer is a fibrillated polytetrafluoroethylene film with first fibrils generally extending in a first layer direction. The second layer is a fibrillated polytetrafluoroethylene film with second fibrils generally extending in a second layer direction. The laminate is formed such that the first layer direction is not coincident with the second layer direction, and a nominal thickness of the laminate is less than about 4.5 mil.

In accordance with another aspect of the invention, a cooking release sheet is also fabricated as a laminate of two layers. In this aspect, the first layer is a fibrillated polytetrafluoroethylene film with first fibrils generally extending in a first layer direction. The second layer is a fibrillated polytetrafluoroethylene film with second fibrils generally extending in a second layer direction. The laminate is formed such that the first layer direction is within about 50 degrees to 70 degrees of the second layer direction.

In accordance with a further aspect of the invention, a cooking release sheet is also fabricated as a laminate of two layers. In this aspect, the first layer is a fibrillated polytetrafluoroethylene film with first fibrils generally extending in a first layer direction. The second layer is a fibrillated polytetrafluoroethylene film with second fibrils generally extending in a second layer direction. The laminate is formed having a heat transfer coefficient of at least about 0.150 W/mK (1.04 Btu/(ft2° F. h)).

### BRIEF DESCRIPTION OF THE DRAWINGS

The following description may be further understood with reference to the accompanying drawings in which:

FIG. 1 shows an illustrative diagrammatic view of a clamshell grill with a cooking release material of the present invention as a cooking release sheet.

FIG. 2 depicts an illustrative diagrammatic view of a sequence of events when using a release material of the prior art.

FIG. 3 depicts an illustrative diagrammatic representation of the release material of the present invention.

FIG. 4 depicts an illustrative diagrammatic view of a sequence of events when using a release material of the present invention.

FIG. 5 depicts an illustrative diagrammatic representation of an alternative aspect of the release material of the present invention.

### DETAILED DESCRIPTION

In accordance with various aspects, the invention provides a cooking release material that facilitates the transfer of heat to cook food items while maintaining structural integrity for repeated use and chemical and mechanical stability for food safety.

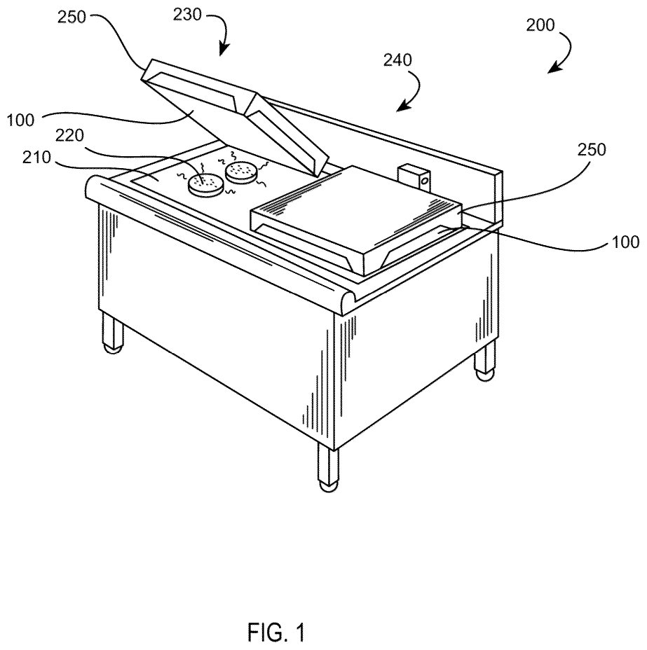

FIG. 1 depicts an embodiment of the cooking release material of the present invention in an illustrative application. As shown in FIG. 1, a clamshell grill 200 with a cooking release material 100 of the present invention is attached to each of the upper cooking elements 250, shown functionally in an open position 230 and a closed position 240. In operation, the food item 220 is placed on the lower cooking surface 210 with the upper cooking element 250 in the open position. The release material 100, which is semi-permanently pre-applied to the upper cooking element 250, is placed in contact with or close proximity to the food item 220 when the upper cooking element 250 is lowered into the closed position 240. The food item 220 quickly cooks with heat from the lower cooking surface 210 transferring directly into it and heat from the upper cooking element 250 transferring through the release material 100 and directly into it. When the cooking cycle is complete, the upper cooking element 250 is raised into the open position 230 to remove the food. The non-stick properties of the release material are necessary so that the food item 220 does not lift with the raising of the upper cooking element 250 and so that it remains on the lower cooking surface for further processing or serving. The release material remains in place for repeated uses, though it can be removed for periodic cleaning and less frequent replacement.

Although PTFE is well-known to provide excellent release (non-stick) surfaces, it is also well-known that PTFE (as with many polymers) expands when heated and lacks structural integrity unless processed into a thicker composite. Any expansion of a release sheet used in a clamshell grill may compromise securement of the release sheet to the upper heating element, and further may impart unacceptable blemishes onto the food product such as wrinkles or depressions from folds of an expanded release liner. In time, such folds may even be subject to wear and separation.

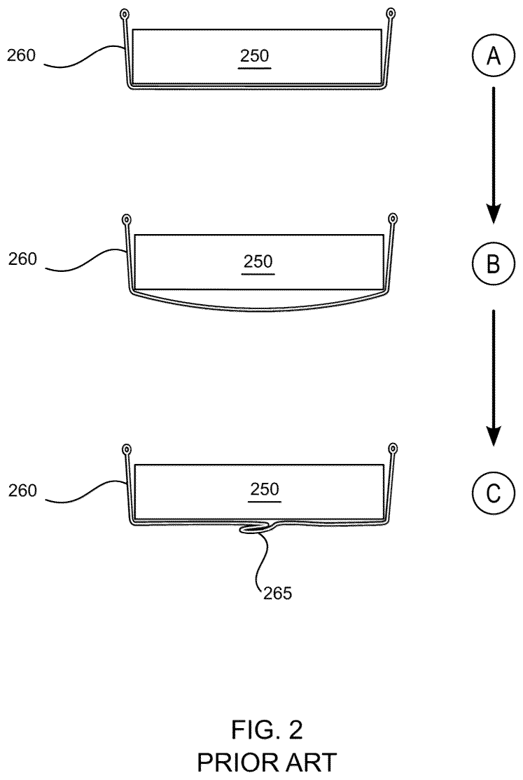

FIG. 2 depicts the sequence of events that may occur with the use of a PTFE material of the prior art when used as a cooking release material for a clamshell grill. PTFE material in sheet form 260 is most commonly skived from larger blocks of PTFE to provide a uniform thickness in sheet form, or cast PTFE which is made up of very thin layers that have been individually deposited, sintered, and fused into a film or sheet. At room temperature, when the conventional release material 260 of the prior art is applied to the cooking element 250, as shown at sequence A of FIG. 2, the conventional release material 260 can be pulled taut to form a flat surface for optimal heat transfer during operation. As the conventional release material 260 is heated, it expands to fit loosely on the cooking element 250, as shown at sequence B of FIG. 2. In the expanded state, during operation, as shown in sequence C of FIG. 2, ripples and folds 265 may occur in the expanded conventional release material 260 that may significantly impact the rate of heat transfer in localized regions resulting in potentially unsafe undercooked food and/or undesirable appearance of the food. PTFE materials exhibit some shrinkage after elastic expansion when heated, but all-PTFE films used for cooking release sheets generally undergo inelastic expansion resulting in a loose fit as a cooking release material that is prone to wrinkles and folds.

To address the inherent failures of pure PTFE materials for cooking release materials, fiberglass reinforcement of thin films of PTFE have been produced that effectively limit the expansion of the heated release material to that of the reinforcement, but as noted above, the composite structure is known to degrade during some use leading to potential contamination of the cooked food from the reinforcement material.

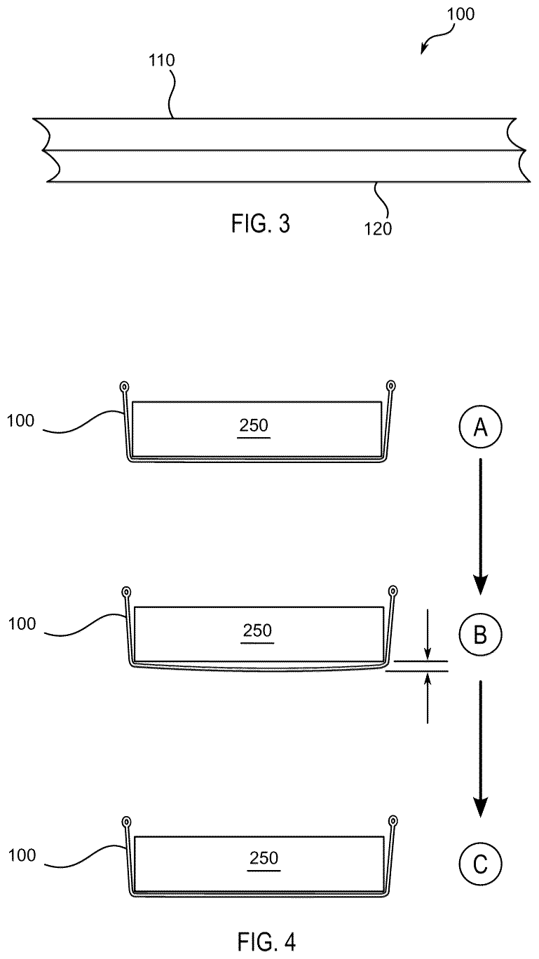

The cooking release material 100 of the present invention is a homogeneous (non-composite) PTFE film material that reduces the amount of expansion at typical cooking temperatures and exhibits a larger than expected amount of shrinkage when cooled resulting in a self-correcting release sheet free of the detrimental effects of thermal cycling in a cooking environment. As shown in FIG. 3, the release material 100 is made up of at least two very thin layers of fibrillated PTFE. One layer 110 with first fibrils generally extending in a first layer direction and another layer 120 of fibrillated PTFE film with second fibrils generally extending in a second layer direction, the layers being fused and sintered into a laminate. In an aspect of the invention, the laminate is two layers of 1.0 mil (0.0254) films with a nominal thickness of approximately 2.0 mil (0.0508 mm), to provide a maximum heat transfer for optimal searing of foods when cooked. In another aspect of the invention, the laminate is two layers of 2.0 mil (0.0508) films with a nominal thickness being less than about 4.5 mil (0.114 mm). In yet another aspect of the invention the laminate is three layers of 1.0 mil (0.0254) films with a nominal thickness of approximately 3.0 mil (0.0762 mm) that provide a higher level of ruggedness and longevity in a high volume operation with a lower level of heat transfer sensitivity where many different types of food is cooked with seasoning. For the most rugged applications where heat transfer is not a concern, an embodiment is a laminate of three-to five layers of 1.0 mil (0.0254) films to 2.0 mil (0.0508) films for a nominal thickness of 5-10 mils (0.127-0.254 mm).

FIG. 4 depicts the sequence of events that may occur with the use of the material of the present invention when used as a cooking release material for a clamshell grill. At room temperature, when the release material 100 is applied to the cooking element 250, as shown at sequence A of FIG. 4, the release material 100 can be pulled taut to form a flat surface for optimal heat transfer during operation. As the release material 100 is heated, it expands slightly to fit loosely on the cooking element 250, as shown at sequence B of FIG. 4. In this expanded state, during operation, no ripples or folds are observed as the expanded release material 100 has no negative impact on the rate of heat transfer in any localized regions that could result in potentially unsafe undercooked food and/or undesirable appearance of the food. As shown in sequence C of FIG. 4, as the release material 100 of the present invention returns to room temperature, no folds or creases can occur since the increased shrinkage induced in the effective machine direction of each of the laminated layers offsets the expansion when heated, resulting in a taut release sheet 100 disposed on the face of the cooking element 250.

While homogeneous (non-reinforced) PTFE laminates have been used in making conveyor belts for use in food service and food production industries, such conveyor belts would not be suitable for use as release liners for clamshell grills for a number of reasons. U.S. Pat. No. 7,673,742 (the disclosure of which is hereby incorporated by reference in its entirety), for example, discloses an all-PTFE conveyor belt for use in food preparation, packaging and chemical processing. The belt is formed of many plies (e.g., nine) of dry fibrillated PTFE cross films that are prestressed in a lengthwise (belt) direction to “increase its laminated yield strength to an elevated level selected to be at least as high, and preferably above that of the maximum operational stresses that the belt is expected to encounter in the intended conveyor application.” U.S. Pat. No. 7,211,210 (the '210 patent, incorporated herein by reference), col. 2, lines 52-57.

Following prestressing, the laminate in the '210 patent is disclosed to have a thickness reduced from prior to prestressing of over 117 mils down to 5 mils to 20 mils. Such thicknesses, however, may be too great to meet the requirements of certain applications, even prestressed, of providing rapid heat transfer from the upper heating element to the food product. Any thickness of a polymer-based release sheet over about even 5 mils may cause the release liner to increase the time it takes to cook the food product on the lower heating element. Further, prestressing such a PTFE laminate release sheet may impart anisotropic (directional) properties to the release sheet that may cause ripples or ridges due to any thermal expansion (upon heating) or shrinkage (upon cooling).

It is known that PTFE undergoes elastic thermal expansion above 19° C. due to stretching, and as the temperature rises the crystal form of PTFE changes (Phase Transition Behavior and Deformation Mechanism of Polytetrafluoroethylene under stretching, by C. Luo, J. Pei, W. Zhou, Y. Niu and G. KLi, RSC Adv., Royal Society of Chemistry, 2021, 11, 39813-39820). Such stretching may even result from gravitational forces such as may be applied to a release sheet on an upper heating element of a clamshell grill.

As reported by Lou et al. above, when PTFE is stretched “the deformation and orientation behavior under stretching of PTFE directly correlate with its special crystal phases and their transitions” (Id., at 39813). Applicant has discovered that under certain conditions, a thin laminate of homogeneous PTFE films may be designed that reduces the expansion the expansion of the film due to the dry fibrillation process when heated. When extruded PTFE is stretched in a dry fibrillation process as disclosed for example in U.S. Pat. No. 7,211,210 (the disclosure of which is hereby incorporated by reference in its entirety), the resulting fibrils in the PTFE impart increased elastic strength to the PTFE.

Applicant has discovered that laminating fewer than four, and preferably even just two sheets of dry fibrillated PTFE at relative orientations of between 50° and 70°, and preferably between about 55° and 65° (e.g., about) 60° and not prestressing the laminate provides the surprising result that the laminate undergoes very little expansion when exposed to elevated temperatures. The reduced expansion is due to the offsetting properties of the laminate in the machine direction where the laminate experiences increased shrinkage in the fibril direction when cooled that will offset expansion of the remaining (non-fibril) PTFE. The laminate is also preferably between about 0.5 mil and under 5 mil (e.g., not above 4.5 mil), and more preferably may be between about 1 mil and about 3 mil (e.g., about 2 mil) in thickness, providing the necessary high heat transfer rate needed for clamshell grill applications. Laminates between about 5 mil and about 10 mil can be used in the most rugged applications where heat transfer is less of a concern but where high utilization and longevity is required. Laminates of various aspects of the invention may have a thermal conductivity of at least about 0.150 W/m K (1.04 Btu/(ft²° F. h)), and preferably may have a thermal conductivity of about 0.167 W/m K (1.16 Btu/(ft²° F. h) to about 0.300 W/m K (2.08 Btu/(ft²° F. h).

The multi-ply (e.g., nine ply) laminate used of the PTFE conveyor belt of U.S. Pat. No. 7,763,742, as noted above, references the layering of oriented PTFE plies as disclosed in U.S. Pat. No. 5,466,531 (the disclosure of which is hereby incorporated by reference in its entirety) prior to prestressing the laminate in the machine direction. The '531 patent discloses layering the oriented PTFE plies at integers of forty-five degree angles from the machine direction ('531 patent, FIGS. 1 and 2) for the purpose of providing high tensile and tear strengths in multiply (e.g., four to sixteen ply) prestressed laminates. Such laminates would not provide the required anisotropic properties nor the high heat transfer rates needed for applications of the present invention such as clamshell grill applications.

### EXAMPLE

In an illustrative embodiment, two plies of dry fibrillated PTFE films were laminated together with directions of the fibrils being sixty degrees apart from one another. The resulting laminate was not prestressed, had a nominal thickness of 2 mils (0.051 mm), a nominal weight of 3.75 oz/yd² (127 g/m²), a tensile strength of 13 lbs./inch (114 N/50 mm), and a tear strength of 12 lbs. (53 N). The laminate had a thermal conductivity of about 0.167 W/m K (1.16 Btu/(ft²° F. h) to about 0.300 W/m K (2.08 Btu/(ft²° F. h), a melting point of about 610° F.-651° F. (321° C.-344° C.). When used as a release liner in a clamshell grill, the upper heating element was used up to 600° F. (316° C.) during continuous use.

A comparison of samples of the illustrative embodiment was performed against various types of conventional PTFE films to demonstrate the net shrinkage of the materials. In each comparison, ten four-inch square samples were dimensionally measured in the machine direction (length of roll) and transverse direction (width of roll). Five were heated to 500 degrees Fahrenheit then cooled to room temperature and re-measured. Five were heated to 550 degrees Fahrenheit then cooled to room temperature and re-measured. The same test was performed for skived PTFE in 2 mil and 5 mil thicknesses and cast PTFE in 2 mil and 5 mil thicknesses. The averages of the five samples of each type are summarized in Table 1.

TABLE 1

| | | 500 F. | | 550 F. | |
|---|---|---|---|---|---|
| Material | Thickness | MD | TD | MD | TD |
| Example | 2 | 4.50% | 0.69% | 6.30% | 0.63% |
| Skived PTFE | 2 | 0.33% | 0.23% | 0.49% | 0.12% |
| Skived PTFE | 5 | 0.62% | 0.28% | 1.10% | 0.26% |
| Cast PTFE | 2 | 2.58% | 2.57% | 3.09% | 2.96% |
| Cast PTFE | 5 | 2.54% | 2.54% | 3.21% | 3.17% |

In each sample, the net shrinkage was negative (the measured dimensions of the samples were smaller after the heating cycle than before) but the samples of the illustrative embodiment of the present invention clearly shows a net shrinkage of nearly twice that of the conventional film products in the machine direction to counteract the inherent expansion of the PTFE material when heated.

In certain aspects of the invention, the release material 100 can also be applied to the surface of the lower cooking surface 210 (not shown). The release material 100 on the lower cooking surface 210 allows for easier and quicker removal of the cooked food item 220. Additionally, more uniform cooking can be achieved and lighter cooking utensils, such as a spatula can be utilized. In this aspect, the release material 100 applied to the lower cooking surface can be secured in place with the surface tension from a small amount of cooking oil between the sheet and the grill cooking surface.

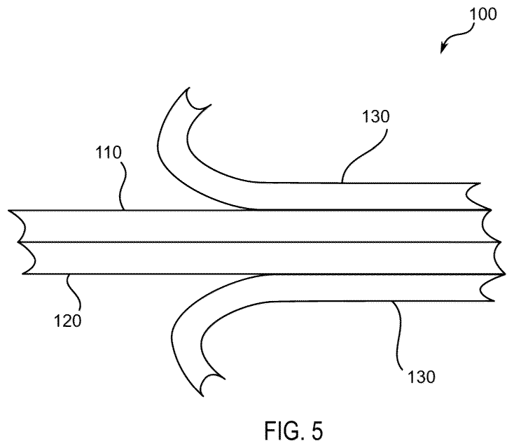

As shown in FIG. 5, in certain aspects of the invention, the release material 100 can be fabricated with additional laminates of combinations of cast PTFE or skived PTFE to form a composite laminate and still provide the advantages of reduced net shrinkage. For example, an aspect of the invention can include a first layer 110 and a second layer 120 of 2.0 mil (0.0508) film, each with a nominal thickness being less than about 4.5 mil (0.114 mm) as described in further detail above, with a 1.0 mil (0.0254) film of cast PTFE film 130 applied to each side of the laminate to provide a composite laminate cooking release sheet. Alternatively, a single sided laminate of a 1.0 mil (0.0254) film of cast PTFE film 130 can be applied to one side of the laminate first layer 110 and a second layer 120 of 2.0 mil (0.0508) film, each with a nominal thickness being less than about 4.5 mil (0.114 mm) as described in further detail above, to provide a composite laminate cooking release sheet. The composite laminate provides less shrinkage/expansion during operation than the prior art films alone, with increased ruggedness and tear resistance provided by the dry fibrillated laminate component. A rip or tear in a cooking release sheet made only of the prior art cast film or skived film materials without the dry fibrillated laminate, the cooking release sheet would be expected to fall apart and require immediate replacement.

Those skilled in the art will appreciate that numerous modifications and variations may be made to the above disclosed aspects without departing from the spirit and scope of the present invention.

What is claimed is:

1. A cooking release material comprising a lamination of:
a first layer of fibrillated polytetrafluoroethylene film with first fibrils generally extending in a first layer direction; and
a second layer of fibrillated polytetrafluoroethylene film with second fibrils generally extending in a second layer direction, the laminate being formed such that the first layer direction is not coincident with the second layer direction, and a nominal thickness of the laminate being less than about 4.5 mil.

2. The cooking release material of claim 1, wherein the nominal thickness of the laminate is less than about 3 mil.

3. The cooking release material of claim 1, wherein the first layer direction is within about 50 degrees to 70 degrees of the second layer direction in the laminate.

4. The cooking release material of claim 2, wherein the first layer direction is about 60 degrees offset from the second layer direction in the laminate.

5. The cooking release material of claim 1, wherein the laminate has a heat transfer coefficient of at least about 0.150 W/mK (1.04 Btu/(ft²° F. h)).

6. The cooking release material of claim 1, wherein the lamination further comprises a third layer of fibrillated polytetrafluoroethylene film with third fibrils generally extending in a third layer direction.

7. The cooking release material of claim 6, wherein the third layer direction is about 60 degrees offset from at least one of the first and second layer and not coincident with either of the first or second layer.

8. The cooking release material of claim 1, wherein the laminate of two layers of fibrillated polytetrafluoroethylene film are laminated with at least one layer of a cast polytetrafluoroethylene film.

9. The cooking release material of claim 1, wherein the laminate of two layers of fibrillated polytetrafluoroethylene film are laminated with at least one layer of a skived polytetrafluoroethylene film.

10. A cooking release material comprising a lamination of:
a first layer of fibrillated polytetrafluoroethylene film with first fibrils generally extending in a first layer direction; and
a second layer of fibrillated polytetrafluoroethylene film with second fibrils generally extending in a second layer direction, the laminate being formed such that the first layer direction is within about 50 degrees to 70 degrees of the second layer direction.

11. The cooking release material of claim 10, wherein the first layer direction is about 60 degrees offset from the second layer direction in the laminate.

12. The cooking release material of claim 10, wherein a nominal thickness of the laminate is less than about 4.5 mil.

13. The cooking release material of claim 12, wherein the nominal thickness of the laminate is less than about 10 mil.

14. The cooking release material of claim 10, wherein the laminate has a heat transfer coefficient of at least about 0.150 W/mK (1.04 Btu/(ft²° F. h)).

15. The cooking release material of claim 10 wherein the lamination further comprises a third layer of fibrillated polytetrafluoroethylene film with third fibrils generally extending in a third layer direction.

16. The cooking release material of claim 10, wherein the third layer direction is about 60 degrees offset from at least one of the first and second layer and not coincident with either of the first or second layer.

17. The cooking release material of claim 10, wherein the laminate of two layers of fibrillated polytetrafluoroethylene film are laminated with at least one layer of a cast polytetrafluoroethylene film.

18. The cooking release material of claim 10, wherein the laminate of two layers of fibrillated polytetrafluoroethylene film are laminated with at least one layer of a skived polytetrafluoroethylene film.

19. A cooking release material comprising a lamination of:
a first layer of fibrillated polytetrafluoroethylene film with first fibrils generally extending in a first layer direction; and
a second layer of fibrillated polytetrafluoroethylene film with second fibrils generally extending in a second layer direction, the laminate being formed having a heat transfer coefficient of at least about 0.150 W/mK (1.04 Btu/(ft²° F. h)).

20. The cooking release material of claim 19, wherein a nominal thickness of the laminate is less than about 4.5 mil.

21. The cooking release material of claim 20, wherein the nominal thickness of the laminate is less than about 10 mil.

22. The cooking release material of claim 19, wherein the first layer direction is within about 50 degrees to 70 degrees of the second layer direction in the laminate.

23. The cooking release material of claim 22, wherein the first layer direction is about 60 degrees offset from the second layer direction in the laminate.

24. The cooking release material of claim 19, wherein the lamination further comprises a third layer of fibrillated polytetrafluoroethylene film with third fibrils generally extending in a third layer direction.

25. The cooking release material of claim 24, wherein the third layer direction is about 60 degrees offset from at least one of the first and second layer and not coincident with either of the first or second layer.

26. The cooking release material of claim 19, wherein the laminate of two layers of fibrillated polytetrafluoroethylene film are laminated with at least one layer of a cast polytetrafluoroethylene film.

27. The cooking release material of claim 19, wherein the laminate of two layers of fibrillated polytetrafluoroethylene film are laminated with at least one layer of a skived polytetrafluoroethylene film.
